(19) United States
(12) Patent Application Publication
(10) Pub. No.: US 2024/0412544 A1
(43) Pub. Date: Dec. 12, 2024

(54) INFORMATION PROCESSING DEVICE, AND PROCESSING METHOD

(71) Applicant: Mitsubishi Electric Corporation, Tokyo (JP)

(72) Inventors: Yusuke ITANI, Tokyo (JP); Yoshiki MITSUI, Tokyo (JP)

(73) Assignee: Mitsubishi Electric Corporation, Tokyo (JP)

(21) Appl. No.: 18/805,616

(22) Filed: Aug. 15, 2024

Related U.S. Application Data
(63) Continuation of application No. PCT/JP2022/017581, filed on Apr. 12, 2022.

(51) Int. Cl. G06V 30/19; G06V 30/18

(52) U.S. Cl. CPC G06V 30/1916; G06V 30/18; G06V 30/19007

(57) ABSTRACT

An information processing device includes an acquisition unit that acquires an image including a first symbol and a plurality of character strings and a relationship table indicating a correspondence relationship between a symbol and a character string, an extraction unit that extracts the first symbol and the plurality of character strings based on the image, a distance calculation unit that calculates distances between the first symbol and the plurality of character strings based on a position of the first symbol and positions of the plurality of character strings, and a determination unit that determines a character string having a relationship with the first symbol based on the relationship table and the distances.

### CROSS-REFERENCE TO RELATED APPLICATION

This application is a continuation application of International Application No. PCT/JP2022/017581 having an international filing date of Apr. 12, 2022, which is hereby expressly incorporated by reference into the present application.

### BACKGROUND OF THE INVENTION

### 1. Field of the Invention

The present disclosure relates to an information processing device, and a processing method.

### 2. Description of the Related Art

There has been known an image analysis device. The image analysis device analyzes an image. For example, symbols and character strings are included in the image as the analysis object. There has been known a technology for extracting symbols and character strings (see Patent Reference 1 or Non-patent Reference 1).

Patent Reference 1:Japanese Patent No. 6076128

Non-patent Reference 1:Shogo Yoneyama, Takashi Hirano and Yasuhiro Okada, “Extracting Symbol Information in Engineering Drawing Image”, March Proceedings of the IEICE General Conference, March 2006

Non-patent Reference 2: T. Hirano et al., “Structural Character Recognition Using Simulated Annealing”, ICDAR 1997 Aug. 1997

Incidentally, there are cases where a plurality of character strings exist around a symbol. In such cases, there is a problem in that it is unclear which character string and the symbol are associated with each other.

### SUMMARY OF THE INVENTION

An object of the present disclosure is to make a determination on appropriate association.

An information processing device according to an aspect of the present disclosure is provided. The information processing device includes an acquisition unit that acquires an image including a first symbol and a plurality of character strings and relationship information indicating a correspondence relationship between a symbol and a character string, an extraction unit that extracts the first symbol and the plurality of character strings based on the image, a distance calculation unit that calculates distances between the first symbol and the plurality of character strings based on a position of the first symbol and positions of the plurality of character strings, and a determination unit that determines a character string having a relationship with the first symbol based on the relationship information and the distances.

According to the present disclosure, it is possible to make a determination on appropriate association.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing hardware included in an information processing device in a first embodiment;

FIG. 2 is a block diagram showing functions of the information processing device in the first embodiment;

FIG. 3 is a diagram showing an example of an image in the first embodiment;

FIG. 4 is a diagram showing an example of an extraction result in the first embodiment;

FIG. 5 is a diagram showing an example of a relationship table in the first embodiment;

FIG. 6 is a block diagram showing functions of an association determination unit in the first embodiment;

FIG. 7 is a flowchart showing an example of a process executed by the information processing device in the first embodiment;

FIG. 8 is a block diagram showing functions of an information processing device in a second embodiment;

FIG. 9 is a block diagram showing functions of an association determination unit in the second embodiment;

FIG. 10 is a flowchart showing an example of a process executed by the information processing device in the second embodiment;

FIG. 11 is a block diagram showing functions of an information processing device in a third embodiment;

FIG. 12 is a diagram showing an example of correction information in the third embodiment;

FIG. 13 is a flowchart showing an example of a process executed by the information processing device in the third embodiment;

FIG. 14 is a block diagram showing functions of an information processing device in a fourth embodiment;

FIG. 15 is a diagram showing an example of correction information in the fourth embodiment;

FIG. 16 is a block diagram showing functions of an association determination unit in the fourth embodiment;

FIG. 17 is a diagram showing an example of the image in the fourth embodiment; and

FIG. 18 is a diagram showing an example of a determination result list in the fourth embodiment.

### DETAILED DESCRIPTION OF THE INVENTION

Embodiments will be described below with reference to the drawings. The following embodiments are just examples and a variety of modifications are possible within the scope of the present disclosure.

### First Embodiment

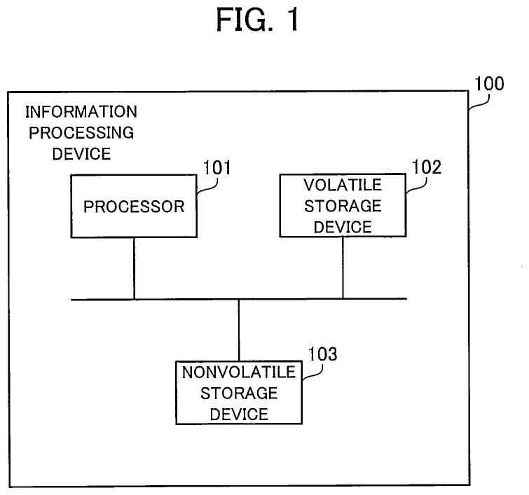

FIG. 1 is a diagram showing hardware included in an information processing device in a first embodiment. The information processing device 100 is a device that executes a processing method. The information processing device 100 includes a processor 101, a volatile storage device 102 and a nonvolatile storage device 103.

The processor 101 controls the whole of the information processing device 100. The processor 101 is a Central Processing Unit (CPU), a Field Programmable Gate Array (FPGA) or the like, for example. The processor 101 can also be a multiprocessor. Further, the information processing device 100 may include processing circuitry.

The volatile storage device 102 is main storage of the information processing device 100. The volatile storage device 102 is a Random Access Memory (RAM), for example. The nonvolatile storage device 103 is auxiliary storage of the information processing device 100. The nonvolatile storage device 103 is a Hard Disk Drive (HDD) or a Solid State Drive (SSD), for example.

Further, the information processing device 100 may include a scanner or a camera.

Next, functions included in the information processing device 100 will be described below.

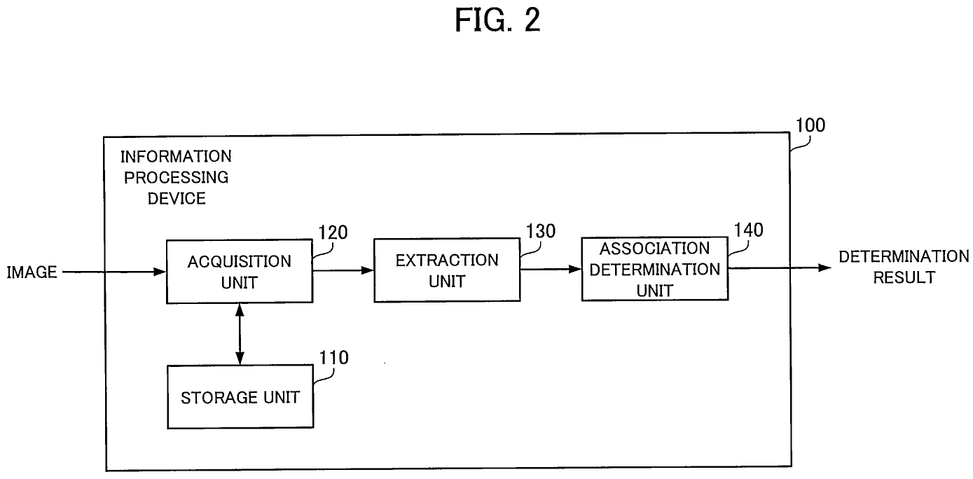

FIG. 2 is a block diagram showing the functions of the information processing device in the first embodiment. The information processing device 100 includes a storage unit 110, an acquisition unit 120, an extraction unit 130 and an association determination unit 140.

The storage unit 110 may be implemented as a storage area reserved in the volatile storage device 102 or the nonvolatile storage device 103.

Part or all of the acquisition unit 120, the extraction unit 130 and the association determination unit 140 may be implemented by processing circuitry. Further, part or all of the acquisition unit 120, the extraction unit 130 and the association determination unit 140 may be implemented as modules of a program executed by the processor 101. For example, the program executed by the processor 101 is referred to also as a processing program. The processing program has been recorded in a record medium, for example.

The acquisition unit 120 acquires an image. For example, in the case where the information processing device 100 includes a camera, the acquisition unit 120 acquires an image obtained by the camera by photographing a target object. Alternatively, for example, the acquisition unit 120 acquires the image from an external device. Incidentally, illustration of the external device is left out. Here, the image will be shown below.

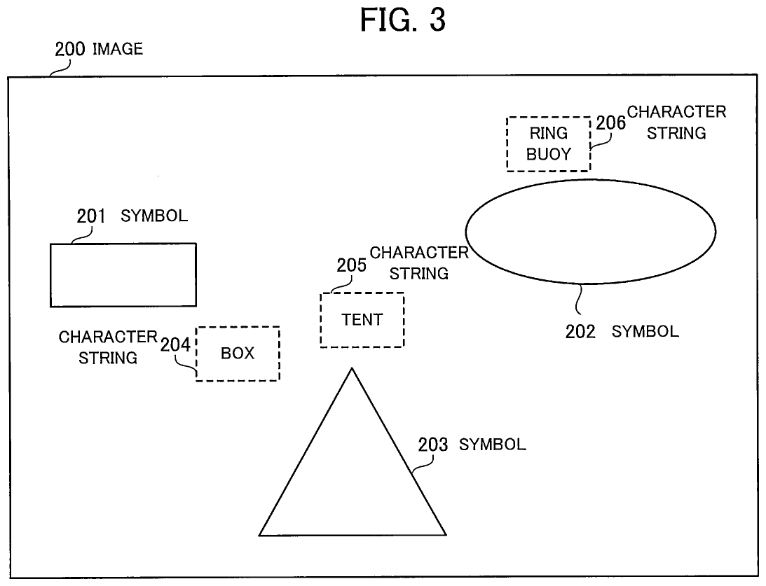

FIG. 3 is a diagram showing an example of the image in the first embodiment. The image 200 is the image acquired by the acquisition unit 120. The image 200 includes symbols 201 to 203 and character strings 204 to 206.

The extraction unit 130 extracts the symbols 201 to 203 and the character strings 204 to 206 based on the image 200. For example, the extraction unit 130 extracts the symbols 201 to 203 and the character strings 204 to 206 by using an extraction method described in the Patent Reference 1 or the Non-patent Reference 1. The result of the extraction will be shown below.

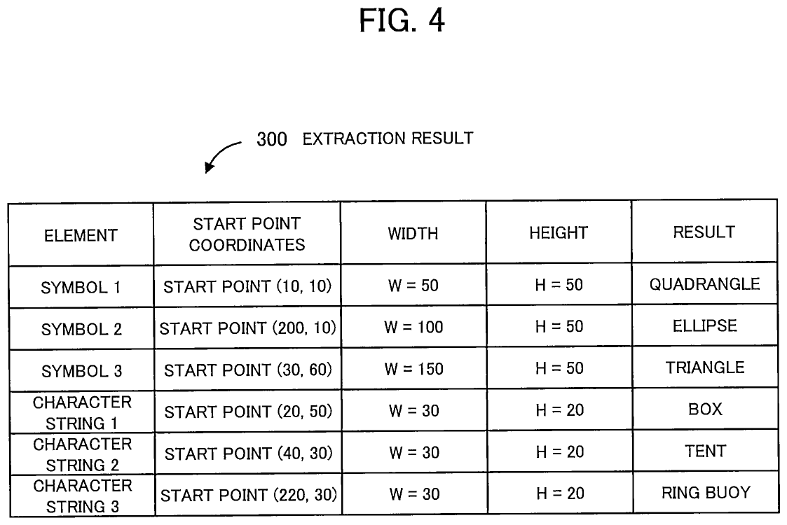

FIG. 4 is a diagram showing an example of the extraction result in the first embodiment. The extraction result 300 includes items of element, start point coordinates, width, height and result. For example, the extraction result 300 indicates that the start point coordinates of a symbol 1 (i.e., the symbol 201) are (10, 10). For example, the extraction result 300 indicates that the width of the symbol 1 is “50” and the height of the symbol 1 is “50”. Further, the extraction result 300 indicates that the shape of the symbol 1 is a quadrangle.

The extraction result 300 may include central coordinates of the symbol instead of the start point coordinates. Here, the start point coordinates, the central coordinates and the like are referred to as position coordinates.

The acquisition unit 120 acquires a relationship table. For example, the acquisition unit 120 acquires the relationship table from the storage unit 110. Alternatively, the acquisition unit 120 acquires the relationship table from an external device. Here, the relationship table will be shown below.

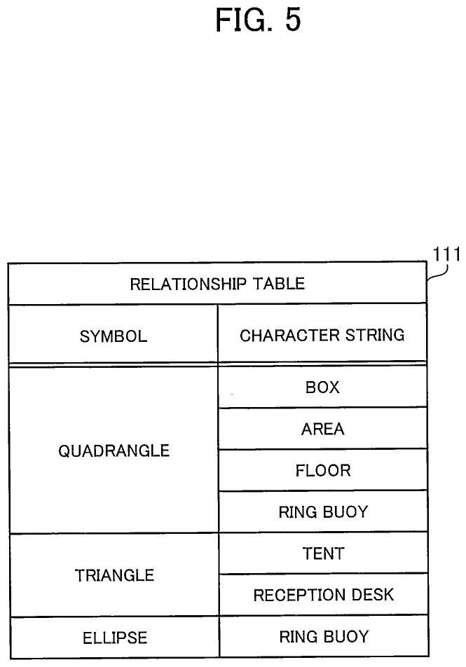

FIG. 5 is a diagram showing an example of the relationship table in the first embodiment. For example, the relationship table 111 has been stored in the storage unit 110. The relationship table 111 is referred to also as relationship information. The relationship table 111 is information indicating a correspondence relationship between a symbol and a character string. For example, the relationship table 111 indicates that “quadrangle” has relationship with “box”, “area”, “floor” and “ring buoy”.

Next, the association determination unit 140 will be described below.

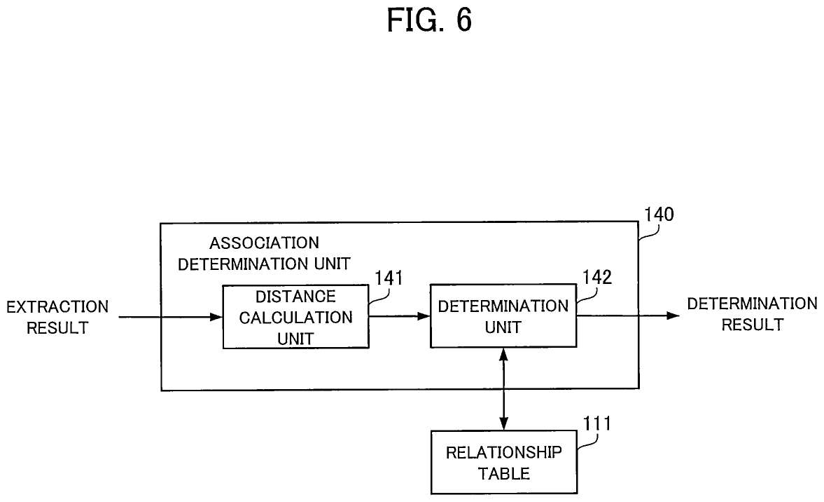

FIG. 6 is a block diagram showing functions of the association determination unit in the first embodiment. The association determination unit 140 includes a distance calculation unit 141 and a determination unit 142.

The distance calculation unit 141 calculates distances between one symbol and a plurality of character strings based on the position of the symbol and the positions of the plurality of character strings. Here, this symbol is referred to also as a first symbol.

For example, the distance L1 between the symbol 201 and the character string 204 is calculated according to expression (1). Specifically, the distance calculation unit 141 calculates the distance L1 based on the position coordinates of the symbol 201 and the position coordinates of the character string 204.

$$L 1 = \sqrt{{( 10 - 20 )}^{2} + {( 10 - 50 )}^{2}} = \sqrt{1700} \qquad ( 1 )$$

The distance L2 between the symbol 201 and the character string 205 is calculated according to expression (2).

$$L 2 = \sqrt{{( 10 - 40 )}^{2} + {( 10 - 30 )}^{2}} = \sqrt{1300} \qquad ( 2 )$$

The distance L3 between the symbol 201 and the character string 206 is calculated according to expression (3).

$$L 3 = \sqrt{{( 10 - 220 )}^{2} + {( 10 - 30 )}^{2}} = \sqrt{44500} \qquad ( 3 )$$

The distance calculation unit 141 calculates the distances between the symbol 202 and the character strings 204 to 206 in a similar manner. Further, the distance calculation unit 141 calculates the distances between the symbol 203 and the character strings 204 to 206 in a similar manner. Incidentally, the distance may be either represented by the Euclidean distance or represented by different representation.

The determination unit 142 determines a character string having a relationship with a symbol based on the relationship table 111 and the distances. In the following, a description will be given of a case of determining a character string having a relationship with the symbol 201. Here, the distances are used in ascending order. According to the above-described calculation results, the distance L2 is the smallest. Therefore, the character string 205 is considered to have a relationship with the symbol 201. The determination unit 142 refers to the relationship table 111. Based on the relationship table 111, the determination unit 142 determines that the symbol 201 (i.e., quadrangle) and the character string 205 (i.e., tent) have no relationship with each other. Subsequently, the determination unit 142 selects the distance L1 that is the second smallest distance. The determination unit 142 refers to the relationship table 111. Based on the relationship table 111, the determination unit 142 determines that the symbol 201 (i.e., quadrangle) and the character string 204 (i.e., box) have a relationship with each other.

The determination unit 142 determines a character string having a relationship with the symbol 202 in a similar manner. Further, the determination unit 142 determines a character string having a relationship with the symbol 203 in a similar manner.

The association determination unit 140 outputs a determination result.

Next, a process executed by the information processing device 100 will be described below by using a flowchart.

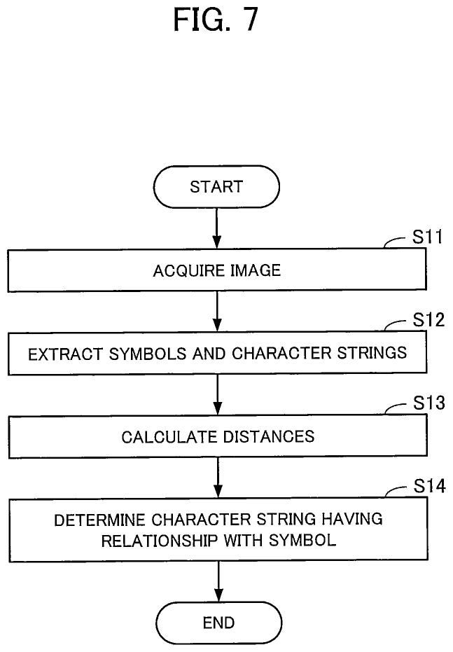

FIG. 7 is a flowchart showing an example of the process executed by the information processing device in the first embodiment.

(Step S11) The acquisition unit 120 acquires the image 200.

(Step S12) The extraction unit 130 extracts the symbols 201 to 203 and the character strings 204 to 206.

(Step S13) The distance calculation unit 141 calculates the distances between the symbol 201 and the character strings 204 to 206. The distance calculation unit 141 calculates the distances between the symbol 202 and the character strings 204 to 206. The distance calculation unit 141 calculates the distances between the symbol 203 and the character strings 204 to 206.

(Step S14) The determination unit 142 determines a character string having a relationship with the symbol 201 based on the relationship table 111 and the distances. The determination unit 142 determines a character string having a relationship with the symbol 202 based on the relationship table 111 and the distances. The determination unit 142 determines a character string having a relationship with the symbol 203 based on the relationship table 111 and the distances.

For example, the character strings 204 to 206 exist around the symbol 201. The information processing device 100 determines that the symbol 201 and the character string 204 have a relationship with each other. Thus, according to the first embodiment, the information processing device 100 is capable of making a determination on appropriate association.

Further, the determination unit 142 determines a character string having a relationship with a symbol based on distances less than or equal to a predetermined threshold value TH among the plurality of calculated distances and the relationship table 111. In other words, the determination unit 142 does not make the determination on whether a character string has a relationship with the symbol or not by using a distance larger than the threshold value TH among the plurality of distances. When the distance between the symbol and a character string is large, the symbol and the character string have no relationship with each other. Therefore, distances larger than the threshold value TH are excluded from information for making the determination. Further, thanks to the exclusion of the distances larger than the threshold value TH, the number of times the determination unit 142 refers to the relationship table 111 decreases. Accordingly, the processing time is shortened.

### Second Embodiment

Next, a second embodiment will be described below. In the second embodiment, the description will be given mainly of features different from those in the first embodiment. In the second embodiment, the description is omitted for features in common with the first embodiment.

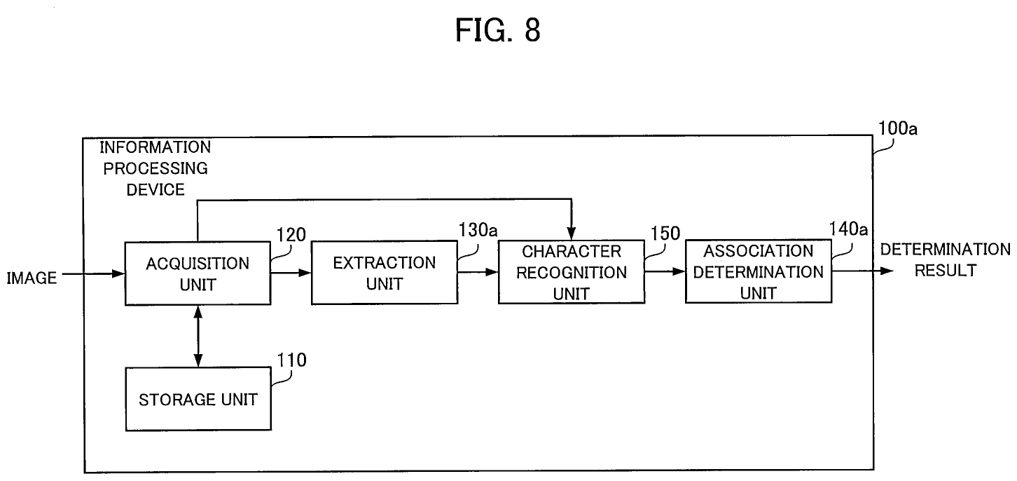

FIG. 8 is a block diagram showing functions of an information processing device in the second embodiment. Each component in FIG. 8 that is the same as a component shown in FIG. 2 is assigned the same reference character as in FIG. 2.

The information processing device 100a includes an extraction unit 130a, an association determination unit 140a and a character recognition unit 150. Part or all of the extraction unit 130a, the association determination unit 140a and the character recognition unit 150 may be implemented by processing circuitry. Further, part or all of the extraction unit 130a, the association determination unit 140a and the character recognition unit 150 may be implemented as modules of a program executed by the processor 101.

The extraction unit 130a extracts the symbols 201 to 203 based on the image 200. Further, the extraction unit 130a extracts the positions of the character strings 204 to 206. That is, the extraction unit 130a does not extract the character strings 204 to 206.

The character recognition unit 150 executes character recognition based on the image. Specifically, the character recognition unit 150 executes the character recognition based on the positions of the character strings 204 to 206. For example, the character recognition unit 150 executes the character recognition by a method described in Non-patent Reference 2. Incidentally, there are cases where the character recognition unit 150 commits a character recognition error. For example, the character recognition unit 150 misrecognizes a character string “tent” as a character string “tesot”.

Next, the association determination unit 140a will be described below.

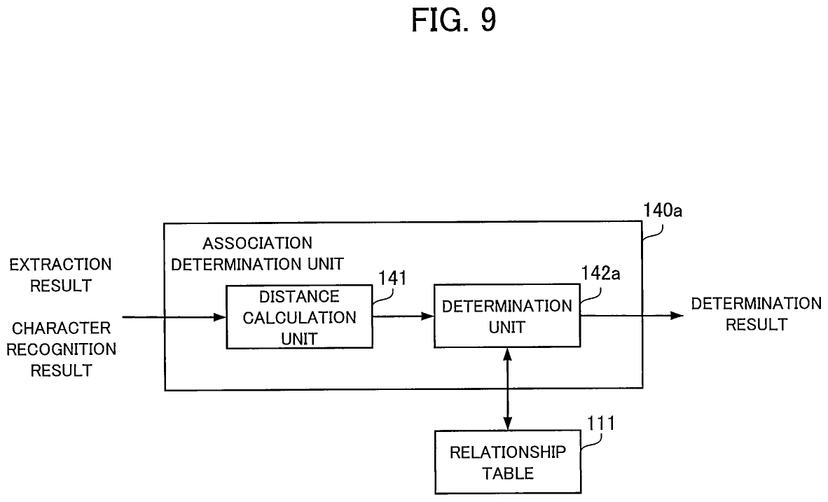

FIG. 9 is a block diagram showing functions of the association determination unit in the second embodiment. The association determination unit 140a includes a determination unit 142a.

The determination unit 142a detects a plurality of character strings which are identical or similar to a plurality of character strings obtained by the character recognition, in the relationship table 111. The determination unit 142a determines a character string having a relationship with a symbol based on the plurality of detected character strings, the relationship table 111, and the distances.

In the following, a description will be given concretely of a case of determining a character string having a relationship with the symbol 203. It is assumed that character strings “box”, “tesot” and “ring buoy” have been obtained by the character recognition. The determination unit 142a detects a character string “box” identical to the character string “box”, in the relationship table 111. The determination unit 142a detects a character string “tent” similar to the character string “tesot”, in the relationship table 111. For example, the determination unit 142a detects a similar character string by making character string comparison. The determination unit 142a detects a character string “ring buoy” identical to the character string “ring buoy”, in the relationship table 111. The determination unit 142a determines a character string having a relationship with the symbol 203 based on the detected character strings “box”, “tent” and “ring buoy”, the relationship table 111, and the distances. The distances are used in ascending order. For example, the determination unit 142a determines based on the relationship table 111 that the symbol 203 (i.e., triangle) and the “tent” have a relationship with each other. The association determination unit 140a outputs a determination result indicating that the symbol 203 (i.e., triangle) and the “tent” have a relationship with each other.

Next, a process executed by the information processing device 100a will be described below by using a flowchart.

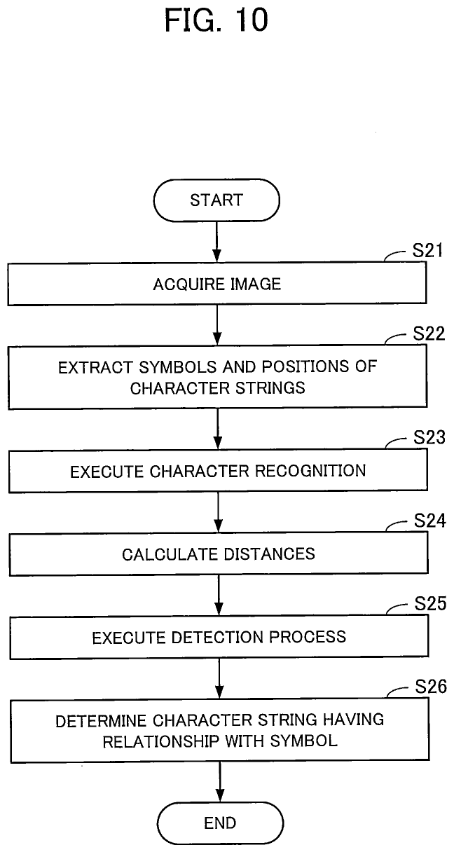

FIG. 10 is a flowchart showing an example of the process executed by the information processing device in the second embodiment.

(Step S21) The acquisition unit 120 acquires the image 200.

(Step S22) The extraction unit 130a extracts the symbols 201 to 203 and the positions of the character strings 204 to 206.

(Step S23) The character recognition unit 150 executes the character recognition based on the image.

(Step S24) The distance calculation unit 141 calculates the distances between the symbol 201 and the character strings 204 to 206. The distance calculation unit 141 calculates the distances between the symbol 202 and the character strings 204 to 206. The distance calculation unit 141 calculates the distances between the symbol 203 and the character strings 204 to 206.

(Step S25) The determination unit 142a detects a plurality of character strings which are identical or similar to a plurality of character strings obtained by the character recognition, in the relationship table 111.

(Step S26) The determination unit 142a determines a character string having a relationship with the symbol 201 based on the plurality of detected character strings, the relationship table 111, and the distances. The determination unit 142a determines a character string having a relationship with the symbol 202 based on the plurality of detected character strings, the relationship table 111, and the distances. The determination unit 142a determines a character string having a relationship with the symbol 203 based on the plurality of detected character strings, the relationship table 111, and the distances.

According to the second embodiment, the information processing device 100a is capable of detecting a character string having a relationship with a symbol even when the character recognition error has occurred.

### Third Embodiment

Next, a third embodiment will be described below. In the third embodiment, the description will be given mainly of features different from those in the first embodiment. In the third embodiment, the description is omitted for features in common with the first embodiment.

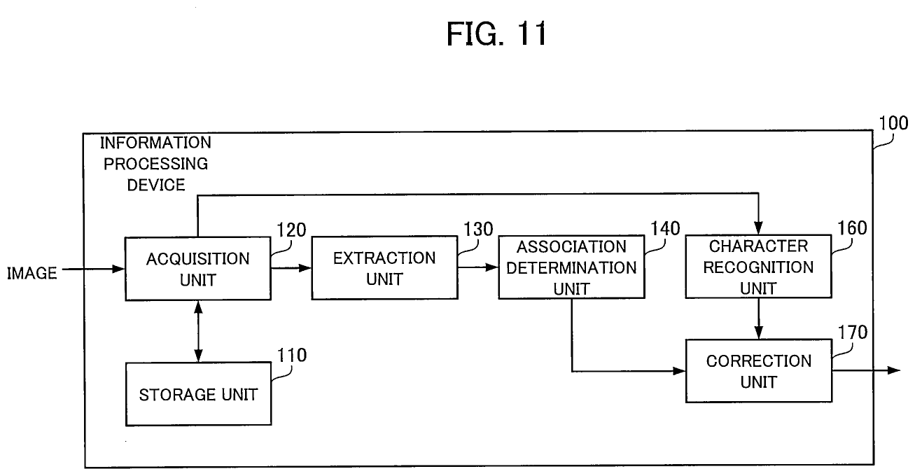

FIG. 11 is a block diagram showing functions of an information processing device in the third embodiment. Each component in FIG. 11 that is the same as a component shown in FIG. 2 is assigned the same reference character as in FIG. 2. The information processing device 100 further includes a character recognition unit 160 and a correction unit 170.

Part or all of the character recognition unit 160 and the correction unit 170 may be implemented by processing circuitry. Further, part or all of the character recognition unit 160 and the correction unit 170 may be implemented as modules of a program executed by the processor 101.

The character recognition unit 160 executes character recognition based on the image. For example, the character recognition unit 160 executes the character recognition by the method described in the Non-patent Reference 2.

The acquisition unit 120 acquires correction information. For example, the acquisition unit 120 acquires the correction information from the storage unit 110. Alternatively, for example, the acquisition unit 120 acquires the correction information from an external device. The correction information will be shown concretely below.

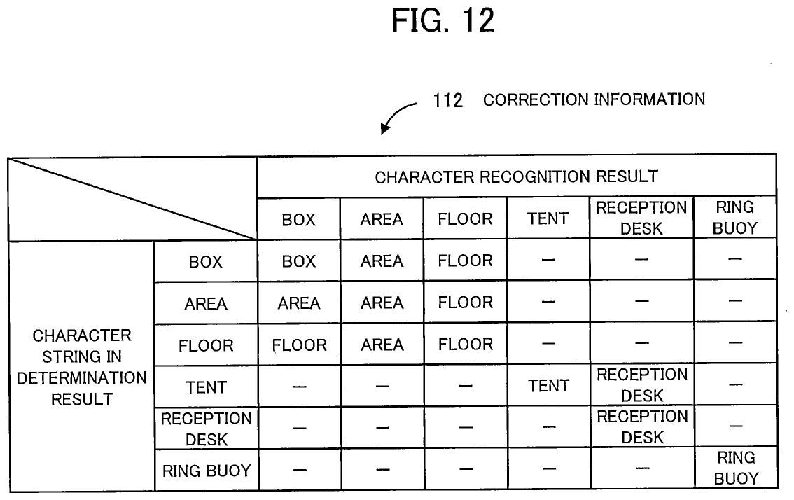

FIG. 12 is a diagram showing an example of the correction information in the third embodiment. For example, the correction information 112 has been stored in the storage unit 110. The correction information 112 is information indicating a character string that should be associated preferentially out of a character string in the character recognition result and a character string in the determination result.

The correction unit 170 identifies a character string that should be associated based on the character string in the determination result, the character recognition result as the result of the character recognition, and the correction information 112. When the character string in the determination result and the identified character string (hereinafter referred to as an identification character string) differ from each other, the correction unit 170 corrects the character string in the determination result to the identification character string. For example, the character recognition result is assumed to be “floor”. The determination result indicates that “quadrangle” and “box” have a relationship with each other. That is, the character string in the determination result is “box”. The correction unit 170 identifies the character string “floor” that should be associated based on the character string “box” in the determination result, the character recognition result “floor”, and the correction information 112. The character string “box” in the determination result and the identification character string “floor” differ from each other. Therefore, the correction unit 170 corrects the character string “box” in the determination result to the identification character string “floor”. Accordingly, information indicating that “quadrangle” and “floor” have a relationship with each other is outputted.

Next, a process executed by the information processing device 100 will be described below by using a flowchart.

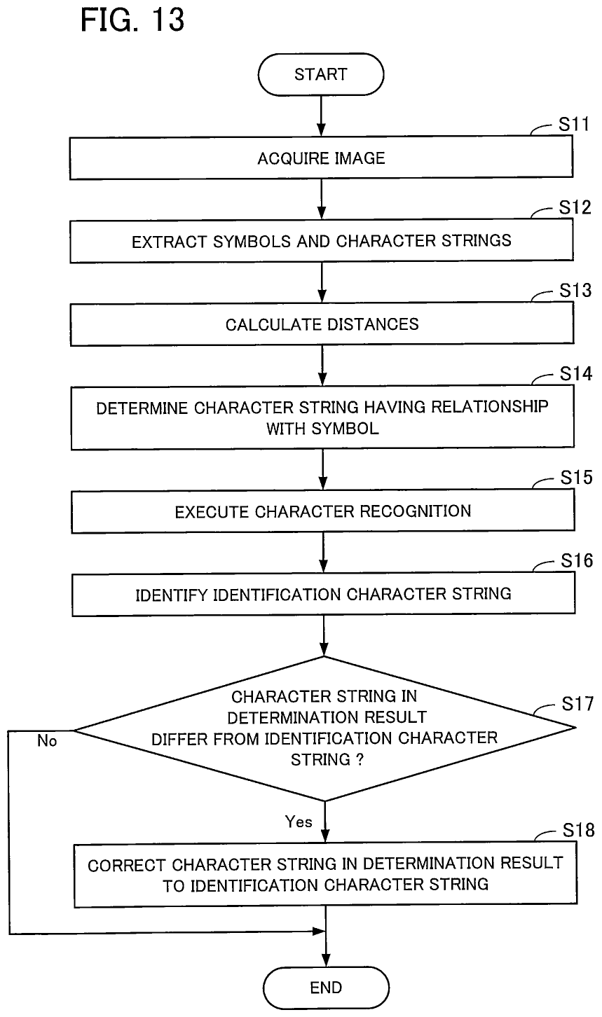

FIG. 13 is a flowchart showing an example of the process executed by the information processing device in the third embodiment. The process of FIG. 13 differs from the process of FIG. 7 in that steps S15 to S18 are executed. Therefore, the steps S15 to S18 will be described below with reference to FIG. 13. Then, the description is omitted for processing other than the steps S15 to S18.

(Step S15) The character recognition unit 160 executes the character recognition based on the image.

(Step S16) The correction unit 170 identifies the identification character string based on the character recognition result and the correction information 112.

(Step S17) The correction unit 170 determines whether or not the character string in the determination result and the identification character string differ from each other. If the two character strings differ from each other, the process advances to step S18. If the two character strings are the same as each other, the information processing device 100 outputs the determination result.

(Step S18) The correction unit 170 corrects the character string in the determination result to the identification character string.

The step S15 may be performed before the step S12. Alternatively, the step S15 may be performed in parallel with the steps S12 to S14.

According to the third embodiment, the information processing device 100 is capable of making association between the character string that should be associated preferentially and the symbol.

Further, the information processing device 100 may execute the following process. The acquisition unit 120 acquires correct answer information of a character string. The correction unit 170 calculates a correct answer level of the character string in the character recognition result as the result of the character recognition based on the correct answer information. Further, the correction unit 170 calculates the correct answer level of the character string in the determination result based on the correct answer information. The correction unit 170 compares the correct answer level of the character string in the character recognition result with the correct answer level of the character string in the determination result. If the correct answer level of the character string in the character recognition result is higher than the correct answer level of the character string in the determination result, the correction unit 170 corrects the character string in the determination result to the character string in the character recognition result.

The above process will be described specifically below. The character recognition result is assumed to be “floor”. The determination result indicates that “quadrangle” and “box” have a relationship with each other. That is, the character string in the determination result is “box”. The correct answer information indicates “floor”. The correction unit 170 calculates the correct answer level of the character string in the character recognition result based on the correct answer information. The correction unit 170 calculates the correct answer level of the character string in the determination result based on the correct answer information. The correction unit 170 determines that the correct answer level of the character string in the character recognition result is higher than the correct answer level of the character string in the determination result. The correction unit 170 corrects the character string “box” in the determination result to the character string “floor” in the character recognition result. Accordingly, information indicating that “quadrangle” and “floor” have a relationship with each other is outputted.

As above, even when the character string in the determination result is erroneous, the information processing device 100 is capable of correcting the character string to an appropriate character string.

### Fourth Embodiment

Next, a fourth embodiment will be described below. In the fourth embodiment, the description will be given mainly of features different from those in the first embodiment. In the fourth embodiment, the description is omitted for features in common with the first embodiment.

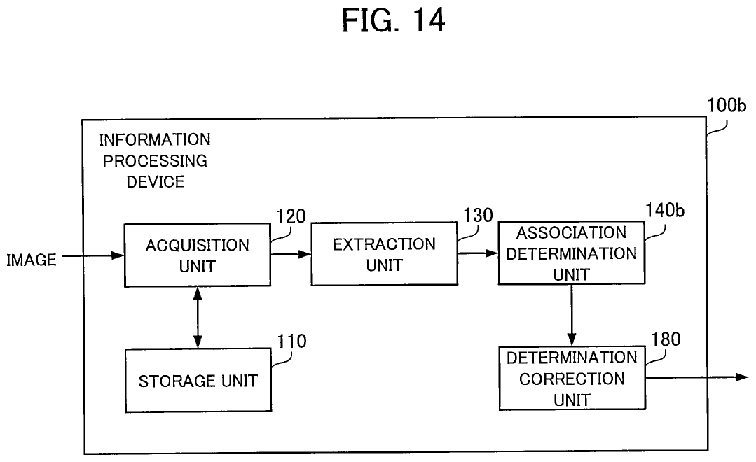

FIG. 14 is a block diagram showing functions of an information processing device in the fourth embodiment. Each component in FIG. 14 that is the same as a component shown in FIG. 2 is assigned the same reference character as in FIG. 2. The information processing device 100b includes an association determination unit 140b and a determination correction unit 180.

Part or all of the association determination unit 140b and the determination correction unit 180 may be implemented by processing circuitry. Further, part or all of the association determination unit 140b and the determination correction unit 180 may be implemented as modules of a program executed by the processor 101.

The acquisition unit 120 acquires correction information. For example, the acquisition unit 120 acquires the correction information from the storage unit 110. Alternatively, for example, the acquisition unit 120 acquires the correction information from an external device. The correction information will be shown concretely below.

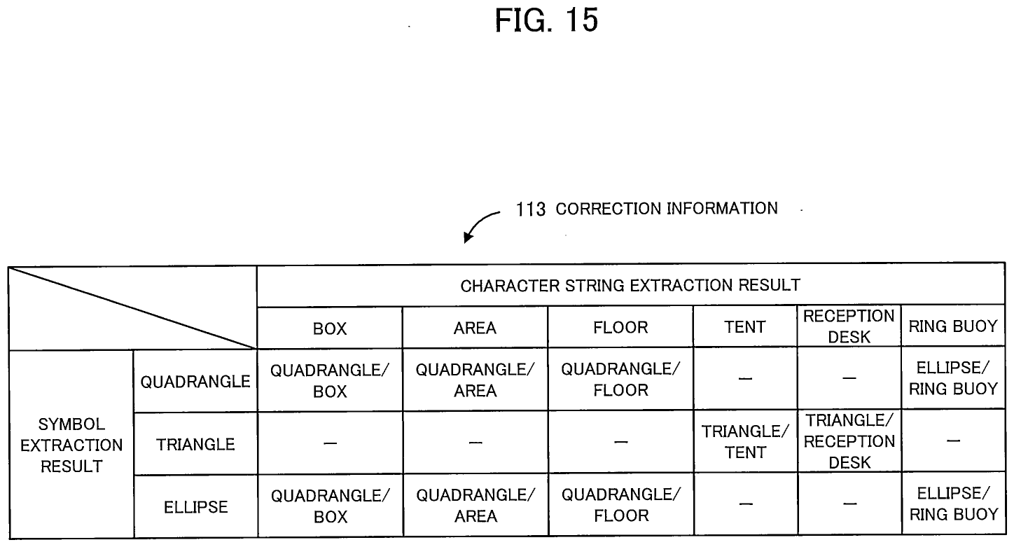

FIG. 15 is a diagram showing an example of the correction information in the fourth embodiment. For example, the correction information 113 has been stored in the storage unit 110. The correction information 113 is information for correcting the determination result. Specifically, the correction information 113 indicates a relationship between an extracted character string and an extracted symbol. A concrete way of using the correction information 113 will be explained later.

Next, the association determination unit 140b will be described below.

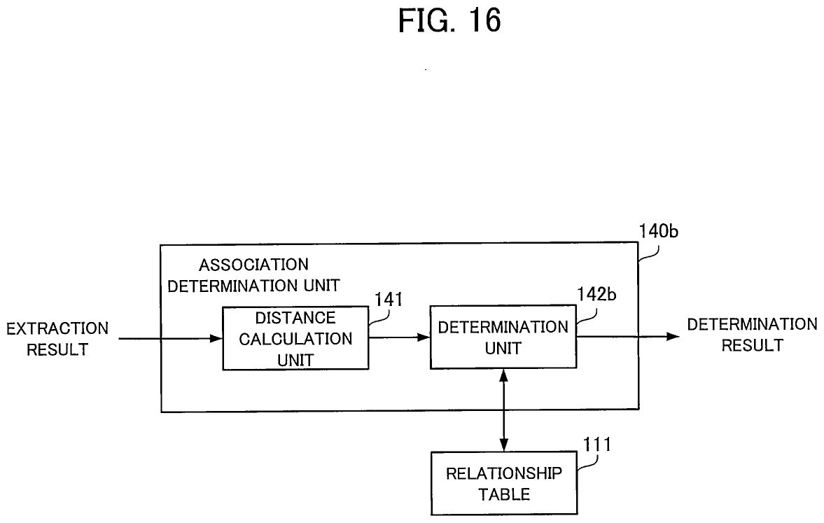

FIG. 16 is a block diagram showing functions of the association determination unit in the fourth embodiment. The association determination unit 140b includes a determination unit 142b.

The determination unit 142b identifies a combination of a symbol and a character string closest to the symbol based on the calculated distances. The determination unit 142b determines whether or not the relationship between the symbol and the character string closest to the symbol has been registered in the relationship table 111. If the relationship has been registered in the relationship table 111, the determination unit 142b outputs the relationship as the determination result.

In the case where the relationship has been registered in the relationship table 111, the determination correction unit 180 determines whether the determination result should be corrected or not based on the correction information 113. When the determination result should be corrected, the determination correction unit 180 corrects the determination result based on the correction information 113.

Next, a process executed by the information processing device 100b will be described below by using concrete examples.

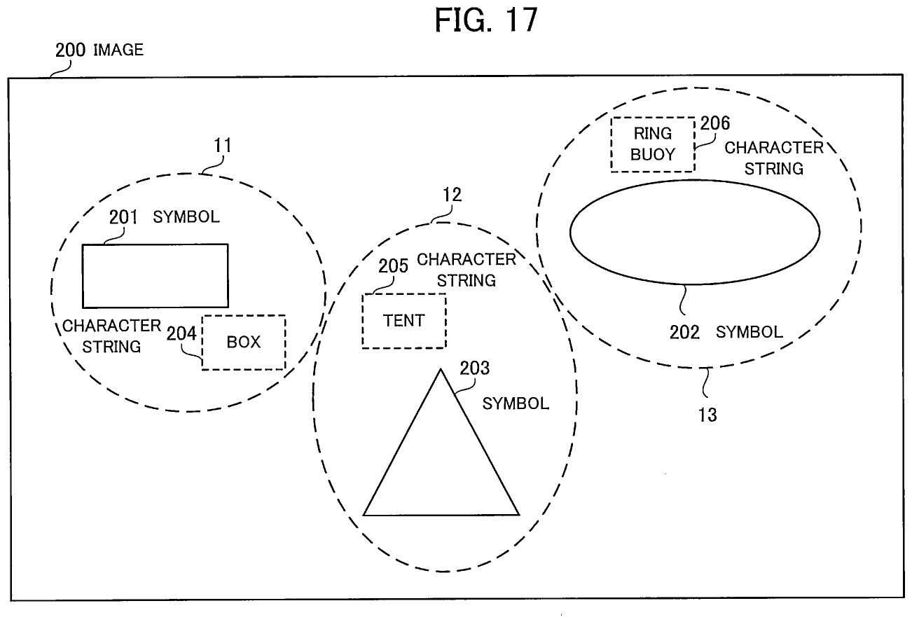

FIG. 17 is a diagram showing an example of the image in the fourth embodiment. The determination unit 142b identifies a combination of the symbol 201 and the character string 204 closest to the symbol 201 based on the calculated distances. In FIG. 17, the combination is indicated as a combination 11. The combination 11 is referred to also as a combination A. The determination unit 142b determines that the combination 11 has been registered in the relationship table 111. The determination correction unit 180 does not correct the determination result since the relationship indicated by the determination result has been registered in the correction information 113.

The determination unit 142b identifies a combination of the symbol 203 and the character string 205 closest to the symbol 203 based on the calculated distances. In FIG. 17, the combination is indicated as a combination 12. The combination 12 is referred to also as a combination B. The determination unit 142b determines that the combination 12 has been registered in the relationship table 111. The determination correction unit 180 does not correct the determination result since the relationship indicated by the determination result has been registered in the correction information 113.

The determination unit 142b identifies a combination of the symbol 202 and the character string 206 closest to the symbol 202. In FIG. 17, the combination is indicated as a combination 13. The combination 13 is referred to also as a combination C. Here, the extraction unit 130 extracts the symbol 202 as “quadrangle”. The determination unit 142b determines that the combination 13 has been registered in the relationship table 111. The determination correction unit 180 corrects the determination result since the relationship indicated by the determination result has not been registered in the correction information 113. Specifically, the determination correction unit 180 corrects the determination result “quadrangle, ring buoy” to “ellipse, ring buoy” based on the correction information 113.

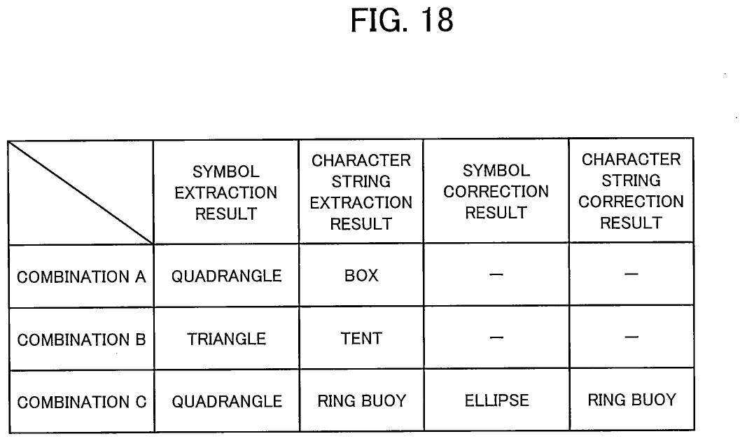

FIG. 18 is a diagram showing an example of a determination result list in the fourth embodiment. The determination result of the combination A indicates that “quadrangle” and “box” have a relationship with each other. The determination result of the combination B indicates that “triangle” and “tent” have a relationship with each other. The determination result of the combination C indicates that “ellipse” and “ring buoy” have a relationship with each other.

As described above, when the extraction unit 130 has extracted the symbol 202 erroneously as “quadrangle”, the determination correction unit 180 corrects “quadrangle” to “ellipse”. Accordingly, the information processing device 100b is capable of correcting an erroneously extracted symbol to a correct symbol. Then, the information processing device 100b is capable of outputting a correct determination result.

Features in the embodiments described above can be appropriately combined with each other.

### DESCRIPTION OF REFERENCE CHARACTERS

100: information processing device, 100a: information processing device, 100b:information processing device, 101: processor, 102: volatile storage device, 103: nonvolatile storage device, 110: storage unit, 111: relationship table, 112: correction information, 113: correction information, 120: acquisition unit, 130: extraction unit, 130a:extraction unit, 140: association determination unit, 140a: association determination unit, 140b: association determination unit, 141: distance calculation unit, 142: determination unit, 142a: determination unit, 142b: determination unit, 150: character recognition unit, 160: character recognition unit, 170: correction unit, 180: determination correction unit, 200: image, 201-203: symbol, 204-206: character string, 300: extraction result

What is claimed is:

1. An information processing device comprising:
acquiring circuitry to acquire an image including a first symbol and a plurality of character strings and relationship information indicating a correspondence relationship between a symbol and a character string;
extracting circuitry to extract the first symbol and the plurality of character strings based on the image;
distance calculating circuitry to calculate distances between the first symbol and the plurality of character strings based on a position of the first symbol and positions of the plurality of character strings;
determining circuitry to determine a character string having a relationship with the first symbol based on the relationship information and the distances;
character recognizing circuitry to execute character recognition based on the image; and
correcting circuitry,
wherein
the acquiring circuitry acquires correction information indicating a character string that should be associated preferentially out of a character string in a character recognition result as a result of the character recognition and a character string in a determination result of the determination, and
the correcting circuitry identifies a character string that should be associated based on the character string in the determination result, the character recognition result and the correction information, and when the character string in the determination result and an identification character string as the identified character string differ from each other, corrects the character string in the determination result to the identification character string.

2. An information processing device comprising:
acquiring circuitry to acquire an image including a first symbol and a plurality of character strings, relationship information indicating a correspondence relationship between a symbol and a character string, and correct answer information of a character string;
extracting circuitry to extract the first symbol and the plurality of character strings based on the image;
distance calculating circuitry to calculate distances between the first symbol and the plurality of character strings based on a position of the first symbol and positions of the plurality of character strings;
determining circuitry to determine a character string having a relationship with the first symbol based on the relationship information and the distances;
character recognizing circuitry to execute character recognition based on the image; and
correcting circuitry,
wherein
the correcting circuitry calculates a correct answer level of a character string in a character recognition result as a result of the character recognition based on the correct answer information, calculates the correct answer level of a character string in a determination result of the determination based on the correct answer information, and when the correct answer level of the character string in the character recognition result is higher than the correct answer level of the character string in the determination result, corrects the character string in the determination result to the character string in the character recognition result.

3. The information processing device according to claim 1, wherein the determining circuitry determines the character string having a relationship with the first symbol based on distances less than or equal to a predetermined threshold value among the plurality of calculated distances and the relationship information.

4. An information processing device comprising:
acquiring circuitry to acquire an image including a first symbol and a plurality of character strings, relationship information indicating a correspondence relationship between a symbol and a character string, and correction information as information for correcting a determination result;
extracting circuitry to extract the first symbol and the plurality of character strings based on the image;
distance calculating circuitry to calculate distances between the first symbol and the plurality of character strings based on a position of the first symbol and positions of the plurality of character strings;
determining circuitry to identify a combination of the first symbol and a character string closest to the first symbol based on the distances and determine whether or not a relationship between the first symbol and the character string closest to the first symbol has been registered in the relationship information;
determination correcting circuitry to determine whether the determination result should be corrected or not based on the correction information when the relationship indicated by the determination result has been registered in the relationship information, and correct the determination result based on the correction information when the determination result should be corrected.

5. A processing method performed by an information processing device, the processing method comprising:
acquiring an image including a first symbol and a plurality of character strings and relationship information indicating a correspondence relationship between a symbol and a character string, extracting the first symbol and the plurality of character strings based on the image, calculating distances between the first symbol and the plurality of character strings based on a position of the first symbol and positions of the plurality of character strings, determining a character string having a relationship with the first symbol based on the relationship information and the distances, executing character recognition based on the image, and acquiring correction information indicating a character string that should be associated preferentially out of a character string in a character recognition result as a result of the character recognition and a character string in a determination result of the determination;
identifying a character string that should be associated based on the character string in the determination result, the character recognition result, and the correction information; and
when the character string in the determination result and an identification character string as the identified character string differ from each other, correcting the character string in the determination result to the identification character string.

6. A processing method performed by an information processing device, the processing method comprising:
acquiring an image including a first symbol and a plurality of character strings, relationship information indicating a correspondence relationship between a symbol and a character string, and correct answer information of a character string, extracting the first symbol and the plurality of character strings based on the image, calculating distances between the first symbol and the plurality of character strings based on a position of the first symbol and positions of the plurality of character strings, determining a character string having a relationship with the first symbol based on the relationship information and the distances and executing character recognition based on the image;
calculating a correct answer level of a character string in a character recognition result as a result of the character recognition based on the correct answer information, and calculating the correct answer level of a character string in a determination result of the determination based on the correct answer information; and
when the correct answer level of the character string in the character recognition result is higher than the correct answer level of the character string in the determination result, correcting the character string in the determination result to the character string in the character recognition result.

7. A processing method performed by an information processing device, the processing method comprising:
acquiring an image including a first symbol and a plurality of character strings, relationship information indicating a correspondence relationship between a symbol and a character string, and correction information as information for correcting a determination result, extracting the first symbol and the plurality of character strings based on the image, and calculating distances between the first symbol and the plurality of character strings based on a position of the first symbol and positions of the plurality of character strings;
identifying a combination of the first symbol and a character string closest to the first symbol based on the distances and determining whether or not a relationship between the first symbol and the character string closest to the first symbol has been registered in the relationship information;
determining whether the determination result should be corrected or not based on the correction information when the relationship indicated by the determination result has been registered in the relationship information; and
correcting the determination result based on the correction information when the determination result should be corrected.

8. An information processing device comprising:
a processor to execute a program; and
a memory to store the program which, when executed by the processor, performs processes of,
acquiring an image including a first symbol and a plurality of character strings and relationship information indicating a correspondence relationship between a symbol and a character string, extracting the first symbol and the plurality of character strings based on the image, calculating distances between the first symbol and the plurality of character strings based on a position of the first symbol and positions of the plurality of character strings, determining a character string having a relationship with the first symbol based on the relationship information and the distances, executing character recognition based on the image, acquiring correction information indicating a character string that should be associated preferentially out of a character string in a character recognition result as a result of the character recognition and a character string in a determination result of the determination,
identifying a character string that should be associated based on the character string in the determination result, the character recognition result and the correction information, and
when the character string in the determination result and an identification character string as the identified character string differ from each other, correcting the character string in the determination result to the identification character string.

9. An information processing device comprising:
a processor to execute a program; and
a memory to store the program which, when executed by the processor, performs processes of,
acquiring an image including a first symbol and a plurality of character strings, relationship information indicating a correspondence relationship between a symbol and a character string, and correct answer information of a character string, extracting the first symbol and the plurality of character strings based on the image, calculating distances between the first symbol and the plurality of character strings based on a position of the first symbol and positions of the plurality of character strings, determining a character string having a relationship with the first symbol based on the relationship information and the distances, executing character recognition based on the image,
calculating a correct answer level of a character string in a character recognition result as a result of the character recognition based on the correct answer information, calculating the correct answer level of a character string in a determination result of the determination based on the correct answer information, and
when the correct answer level of the character string in the character recognition result is higher than the correct answer level of the character string in the determination result, correcting the character string in the determination result to the character string in the character recognition result.

10. An information processing device comprising:
a processor to execute a program; and
a memory to store the program which, when executed by the processor, performs processes of,
acquiring an image including a first symbol and a plurality of character strings, relationship information indicating a correspondence relationship between a symbol and a character string, and correction information as information for correcting a determination result, extracting the first symbol and the plurality of character strings based on the image, calculating distances between the first symbol and the plurality of character strings based on a position of the first symbol and positions of the plurality of character strings,
identifying a combination of the first symbol and a character string closest to the first symbol based on the distances, determining whether or not a relationship between the first symbol and the character string closest to the first symbol has been registered in the relationship information,
determining whether the determination result should be corrected or not based on the correction information when the relationship indicated by the determination result has been registered in the relationship information, and
correcting the determination result based on the correction information when the determination result should be corrected.
